(19) United States
(12) Patent Application Publication
(10) Pub. No.: US 2010/0071494 A1
(43) Pub. Date: Mar. 25, 2010

(54) Ball Screw Unit with Dual Ball Deflect Arrangements

(75) Inventors: Wen-Chia Wu, Taichung (TW); Yan-Yu Chen, Taichung (TW)

Correspondence Address: HDLS IPR Services, PO Box 220746, Chantilly, VA, 20153, US

(73) Assignee: Hiwin Technologies Corp.

(21) Appl. No.: 12/626,875

(22) Filed: Nov. 27, 2009

Related U.S. Application Data
(63) Continuation-in-part of application No. 11/460,904, filed on Jul. 28, 2006, now abandoned.

(51) Int. Cl. F16H 25/22

(52) U.S. Cl. 74/424.87

(57) ABSTRACT

A ball crew unit with dual ball deflect arrangements includes a pair of circulation ball deflect units. One of them is equipped axially in a first cavity provided in the nut, while the other is equipped radially in a second cavity provided in the nut. By so, the traditional buck toothed design for the external helical grooves of the shaft can be eliminated, and is unnecessary to lengthen the nut in order to avoid mutual interference between the ball deflect unit and the nut flange, the circulation tunnel formed in the nut does not have to run through the whole nut either so that the structure of the ball screw unit can be simplified. As a result the assembly work is facilitated, production cost is reduced while the mechanical property is upgraded.

### CROSS REFERENCES RELATED TO THE APPLICATION

This application is a continuation-in-part of U.S. patent application Ser. No. 11/460,904, filed on Jul. 28, 2006.

### BACKGROUND OF THE INVENTION

1. Field of the Invention

The present invention relates to a ball screw unit with dual ball deflect arrangements, and in particular, a ball screw unit equipped with two differently arranged circulation ball deflect units so as to effectively simplify the construction of the componential parts of the ball screw unit and facilitate assembly work as well.

2. Description of the Prior Art

Referring to FIG. 1, U.S. Pat. No. 4,357,838 discloses that a circulation ball deflect unit 28 is inserted into a tunnel of the nut 10 axially from the outer surface thereof, and this tunnel serves as a circulation path. There is an important portion formed on the ball deflect unit 28, that is a protruded portion 68 mainly for connecting the ball deflect unit 28 with a helical track 60. It is to be understood that the protruded portion 68 and the helical track 60 of ball screw 11 is mated with the form of male to female butt joint, one of the end portions of the helical track 60 should be protruded in the manner of a buck tooth so as to facilitate insertion of the ball deflect unit 28. Incidentally such buck toothed design is a weak point for cantilever support.

Referring to FIG. 2, in another U.S. Pat. No. 6,425,302 discloses that a radially inserted ball deflect unit 54 is used which must rely on cover plates 32, 34 and pins 72, 74 to fix onto the nut 10. An axial tunnel 50 formed in the nut 10 serves as a circulation path. Owing to structural problem, the ball deflect unit 54 cannot be formed on flange portion of the nut 10 so that the number of ball turning in the nut 10 is restricted, for a remedy, the nut 10 has to be lengthened which will be not economically feasible.

Besides, in the axial circulation tunnel, it has to run from end to end through the nut causing a chance to accumulate dust.

All the conventional structural designs of ball circulation in ball screw unit including the aforesaid two US patents have inherent flaws of complexity in fabrication and assembly that leads to uprising the production cost, because it is against the present industrious trend, namely, to simplify the mechanical structure by co-using the components.

It is what the reason the inventor of the present invention has put forth every effort for years by continuous research and experimentation in a bid to find out the remedy to palliate the inherent shortcomings of the conventional techniques described above, and at last has come up with the present invention.

### SUMMARY OF THE INVENTION

The present invention is to provide a ball screw unit with dual ball deflect arrangements in which the ball screw unit is equipped with two differently arranged circulation ball deflect units so as to effectively simplify the construction of the ball screw unit and facilitate assembly work as well.

The ball screw unit provided by the present invention has the following structure and features.

A shaft provided with external helical grooves along its outer surface, wherein the external helical grooves are not extended to the stepped portions at two sides of the shaft.

A nut provided with internal helical grooves along its inner surface to mate the external helical grooves of the shaft, at least a pair of cavities is formed in the nut to accommodate a ball deflect unit in each cavity. Of the two cavities, one extends along the axial direction of the shaft and is provided at the side of a flange formed at one end of the nut, the other one is formed on the surface of the nut and radially extended inwardly, it is formed at the other end of the nut where no flange exists. A circulation tunnel is formed in the nut to communicate the axial and radial cavities, which is equipped with the ball deflect units, one end of it reaches the axial cavity to form an opening, while the other end thereof stops at the radial cavity so that the circulation tunnel does not run through the whole nut body.

A plurality of circulation balls roll and slide in the confined region between the external helical grooves of shaft and the internal helical grooves of the nut. A spacer ring may be interposed between the adjacent balls so as to prevent their mutual collision.

At least a pair of circulation ball deflect units from which the circulation balls is fed has one installed at and fixed to the axial cavity in the nut, and the other one installed at and fixed to the radial cavity in the nut. As a whole, the radial ball deflect unit has a spherical surface whose radius of curvature is equal to or less than the outer diameter of the nut. Each ball deflect unit consists of at least one component.

The kernel of the present invention lies in the concept of well cooperation among the sizes of those component parts of the ball screw unit, shaft, nut, ball and ball deflect unit. The idea of employing dual ball deflect arrangements in axial and radial direction is a novel and dexterous structural design to get rid of the buck toothed terminal necessary for the helical track of the ball screw unit in the prior art, and also solves the problem of the conventional construction of radial ball deflect units in both ends of the nut, which though unnecessary to have a back toothed track end, yet has to lengthen the nut in order to prevent the cavity of the ball deflect unit from interfering the flange of the nut. The present invention is really able to effectively reduce the fabrication cost and upraise the productivity.

### BRIEF DESCRIPTION OF THE DRAWINGS

The drawings disclose an illustrative embodiment of the present invention, which serves to exemplify the various advantages and objects hereof, and are as follows:

FIG. 1 is a fragmentary perspective view of a ball screw unit of the first conventional invention;

FIG. 2 is an exploded view of the nut and the ball deflect unit of the second conventional invention;

FIG. 3 is a perspective view of the ball screw unit according to the present invention;

FIG. 4 is a perspective view of the nut in the ball screw unit of the present invention in which the ball deflect units are detached;

FIG. 5 is an exploded view of the ball screw unit according to the present invention;

FIG. 6 through FIG. 8 are respectively first to third illustrative views showing how to assemble the ball screw unit according to the present invention;

FIG. 9 is a completed assembly view of the ball screw unit according to the present invention;

FIG. 10 is a perspective view illustrating the dual deflect arrangements on the nut body according to the present invention;

FIG. 11 is a cross sectional view illustrating the dual deflect arrangements with respect to the nut according to the present invention; and

FIG. 12 is a cross sectional view illustrating a sealing component being used.

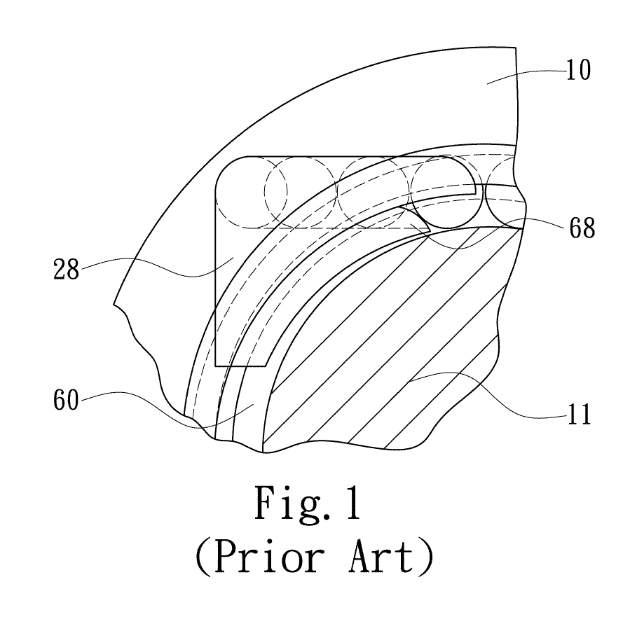

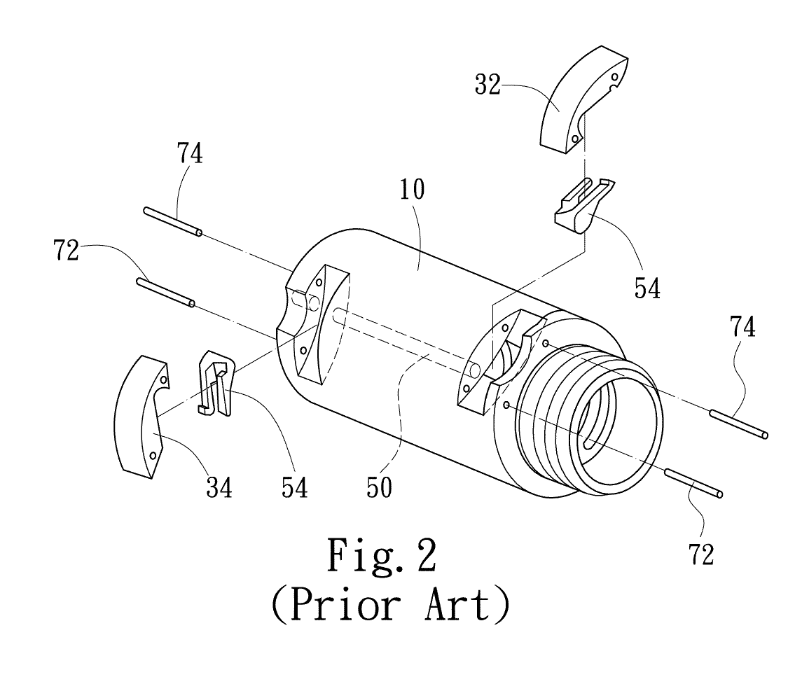

### DETAILED DESCRIPTION OF THE PREFERRED EMBODIMENT

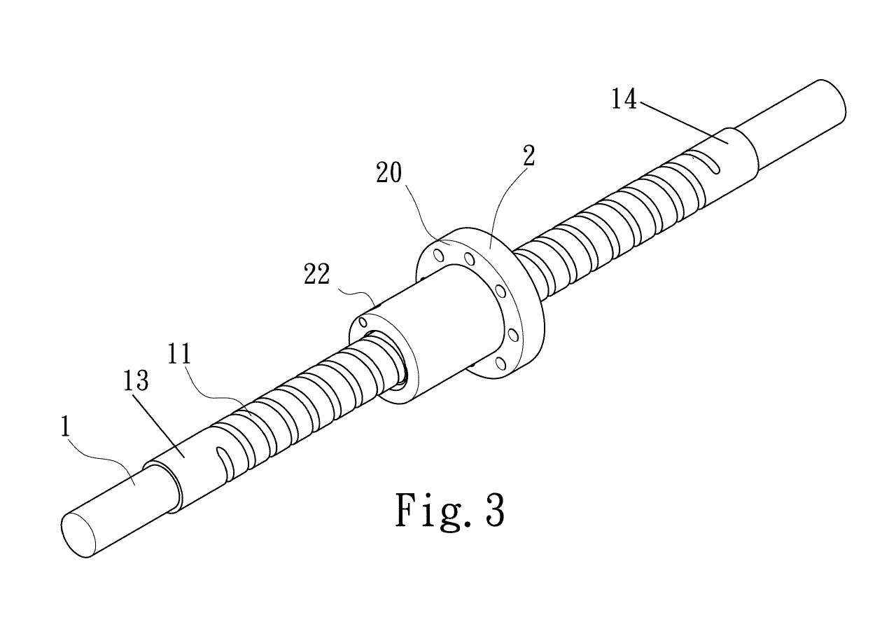

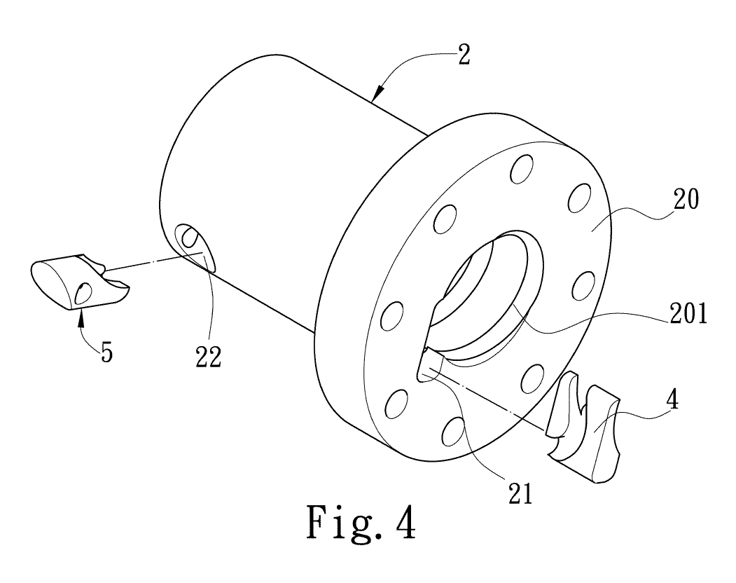

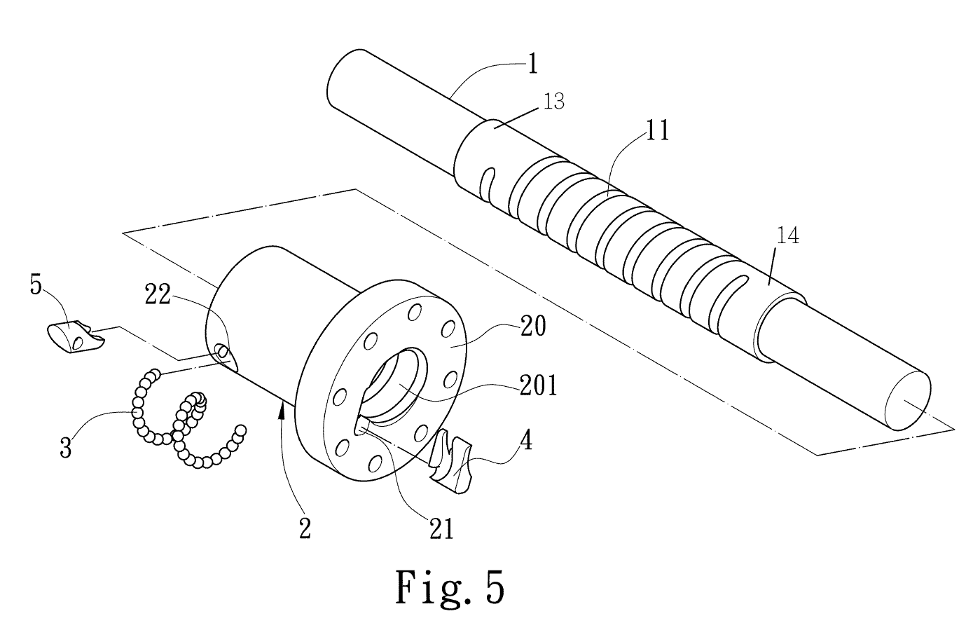

Referring to FIG. 3 and FIG. 4, the ball screw unit with dual ball deflect arrangements according to the present invention comprises a shaft 1, a nut 2, a plurality of circulation balls 3 (referring to FIG. 5) and at least a pair of circulation ball deflect units 4 and 5.

The shaft 1 provided with external helical grooves 11 along its outer surface, wherein the external helical grooves 11 are not extended to the stepped portions 13 and 14 at two sides of the shaft 1. That is, there is a significant smooth surface 13 or 14 at either end of the shaft 1 without being formed the grooves 11 so as to prevent the drawbacks of conventional ball screw unit having the screw grooves all over the shaft as follows.

1. The shaft without the smooth surface at either end cannot provide a complete bearing surface for a bearing, which may result in a non-uniform axial bearing force.

2. The shaft without the smooth surface at either end cannot provide a complete bearing surface for a bearing, which may cause the damage on the bearing.

3. In use, the shaft without the smooth surface at either end may cause the nut accidentally escape from the shaft in various occasions.

4. When the shaft without the smooth surface at either end makes the nut escape from the shaft, the circulation balls will fall out from the nut.

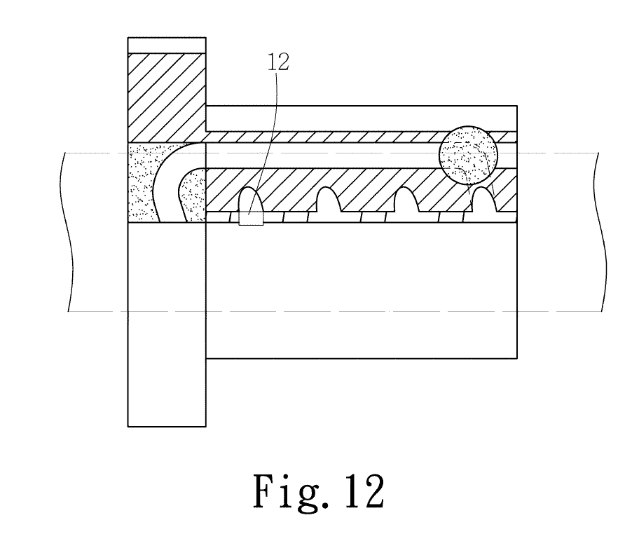

5. The shaft without the smooth surface at either end cannot provide a surface having an outer diameter same as the shaft to be adapted with a sealing component. Referring to FIG. 12, in the present invention, since the shaft 1 at the stepped portion 13 or 14 provides a smooth surface so that a sealing component 12 can be used.

6. The shaft without the smooth surface at either end may cause a supporting portion of shaft formed with the groove, which will result in a gap between the bearing and the supporting portion.

7. The shaft without the smooth surface at either end may hurt a user with the cutting groove.

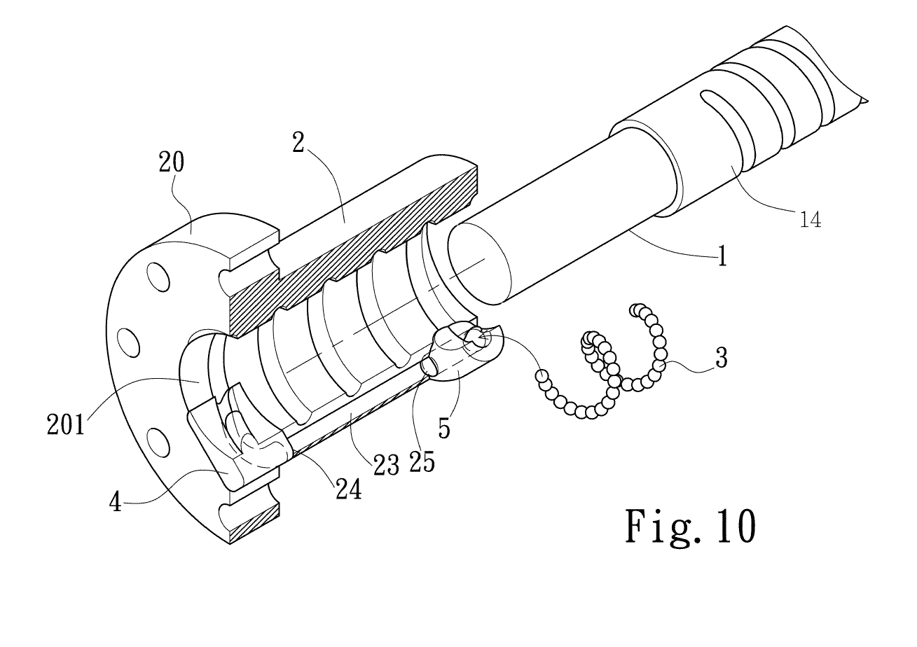

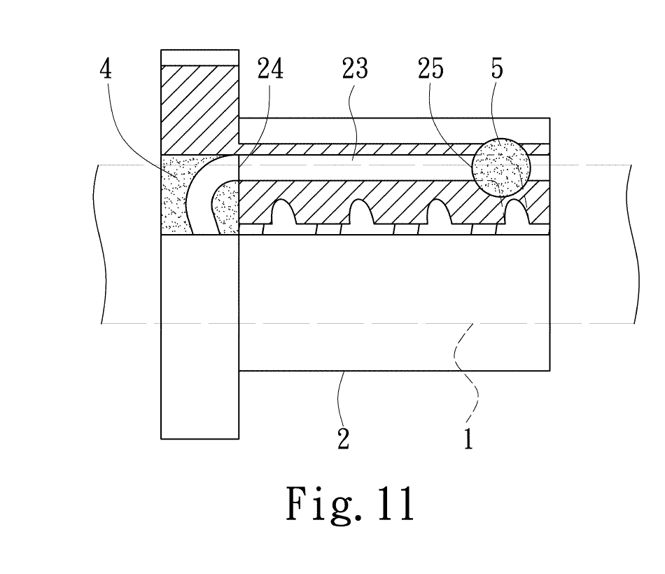

The nut 2 provided with a flange 20 and internal helical grooves 201 formed along its inner surface to mate the external helical grooves 11 of the shaft 1. At least a pair of cavities 21 and 22 is formed in the nut 2 to be equipped with the ball deflect units 4 and 5, respectively. Of the two cavities 21 and 22, the cavity 21 extends along the axial direction of the shaft 1 and is provided at the side of the flange 20 formed at one end of the nut 2, and the other one cavity 22 is formed on the surface of the nut 2 and radially extended inwardly, which is formed at the other end of the nut 2 where no flange 20 exists. As shown in FIG. 10 and FIG. 11, a circulation tunnel 23 is formed in the nut 2 to communicate the axial and radial cavities 21 and 22 which accommodate the ball deflect units 4 and 5. One end of the tunnel 23 reaches the axial cavity 21 to form an opening, while the other end thereof stops at the radial cavity 22 so that the circulation tunnel 23 does not run through the body of nut 2.

The circulation balls 3 roll and slide in the confined region between the external helical grooves 11 of the shaft 1 and the internal helical grooves 201 of the nut 2. A spacer ring (not shown) may be interposed between the adjacent balls 3 so as to prevent their mutual collision.

The pair of circulation ball deflect units 4 and 5 from which the circulation balls 5 are fed has the ball deflect unit 4 installed at and fixed to the axial cavity 21 in the nut 2, and the ball deflect unit 5 installed at and fixed to the radial cavity 22 in the nut 2. As a whole, the radial ball deflect unit 5 has at least a spherical surface whose radius of curvature is equal to or less than the outer diameter of the nut 2, and each of the ball deflect units 4 and 5 consists of at least one components.

Referring to FIG. 5 through FIG. 10, the assembling work of the ball screw unit of the present invention comprises the following steps;

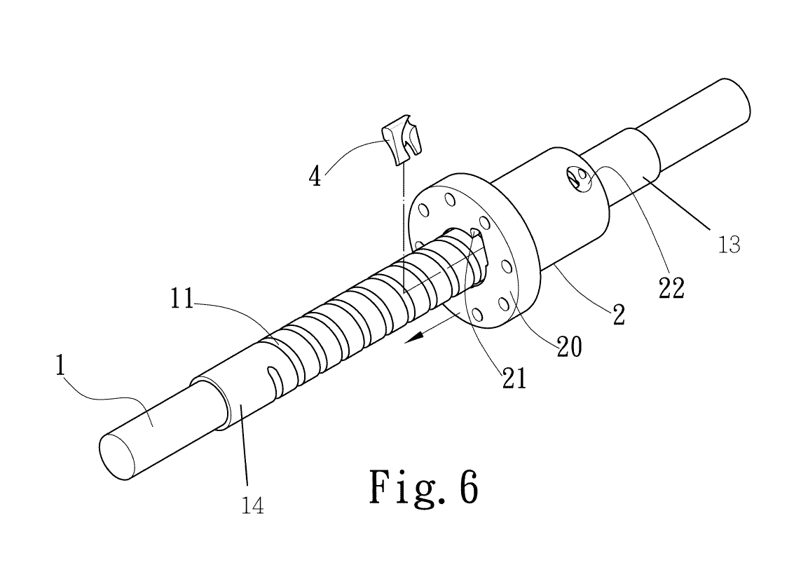

1. Setting the axial ball deflect unit 4 in position on the external helical groove 11, and then moving the nut 2 towards the ball deflect unit 4 until the latter is perfectly settled in position in the cavity 21 of the nut 2 (see FIG. 6)

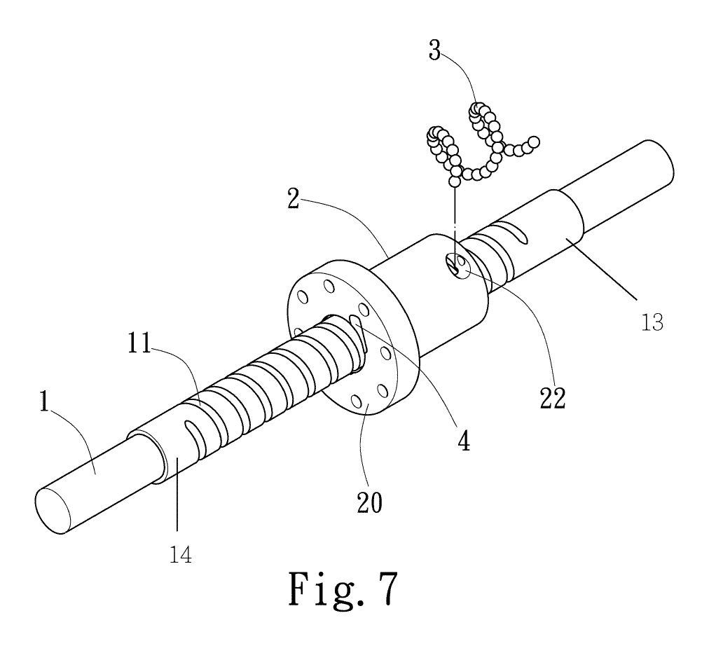

2. Feeding the circulation balls 3 into the nut 2 from the radial cavity 22 until the defined number of balls 3 has spread along the helical track formed between the shaft 1 and the nut 2 (see FIG. 7)

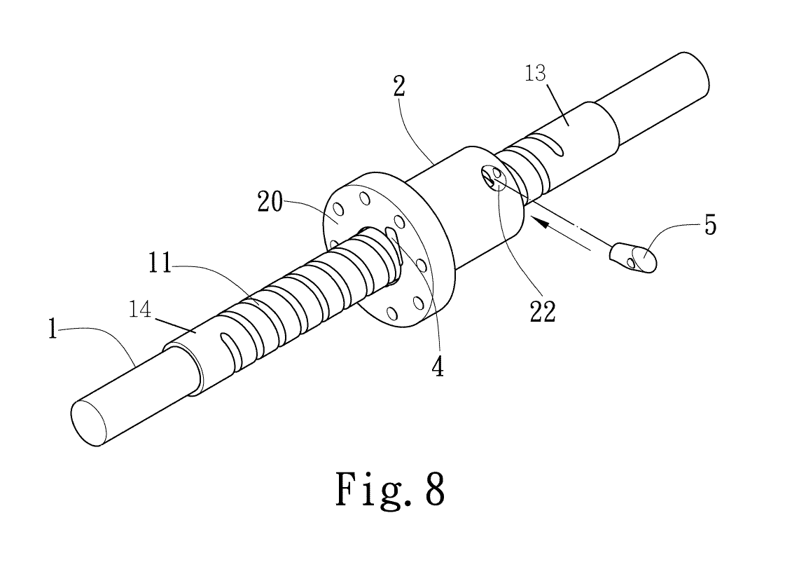

3. Inserting the radial ball deflect unit 5 into the radial cavity 22 formed on the nut 2 until the radial cavity 22 is completely closed (see FIG. 8)

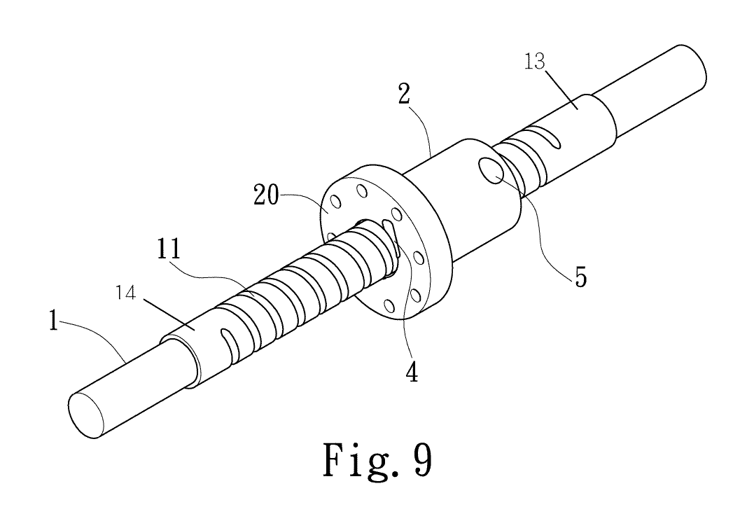

4. Finishing the assembly of a ball screw unit with dual ball deflect arrangements without need of buck toothed end structure for the helical track (see FIG. 9)

After having finished reading over the above detailed description of the present invention, one may clearly understand that the present invention has several features, which are distinctly superior to any other conventional techniques, and are as follows:

1. Well cooperation among the sizes of component parts of ball screw unit to develop the idea of employing dual ball deflect arrangements in axial and radial direction is novel and dexterous never has been thought of in this technical field prior to the present invention.

2. The dual ball deflect arrangements realized elimination of buck toothed terminal necessary for the helical track in the prior arts resulting in curtailing the production cost of the ball screw unit.

3. The interference to the nut flange by the cavity for installing the ball deflect unit is effectively overcome so that it is not necessary to lengthen the shaft to compensate reduction of number of turns for circulation balls.

4. The axial circulation tunnel formed in the nut need not to run through the whole length of nut thereby facilitating the fabrication process and reducing the dust deposition in the circulation tunnel.

5. The dual deflect arrangements contribute to effectively reducing the fabrication cost and upraising the productivity.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A ball screw unit with dual ball deflect arrangements, comprising:
a shaft, having two stepped portions formed at two sides, respectively, provided with external helical grooves which are not extended to the stepped portions along an outer surface thereof;
a nut provided with a flange and internal helical grooves formed along an inner surface thereof to mate the external helical grooves of the shaft, and at least a pair of cavities formed in the nut, wherein of the two cavities, an axial cavity which is provided at a side of the flange formed at one end of the nut extends along an axial direction of the shaft, while a radial cavity which is provided at the other end of the nut where no flange is formed is radially extended inwardly;
a plurality of circulation balls;
a pair of circulation ball deflect units to be respectively installed at and fixed to the axial cavity and the radial cavity; and
a circulation tunnel formed in the nut to communicate the axial cavity and the radial cavity, wherein one end of the tunnel reaches the axial cavity to form an opening, while the other end thereof stops at the radial cavity so that the circulation tunnel does not run through the nut.

2. The ball screw unit of claim 1, wherein the axial ball deflect unit is at first set in position on the external helical grooves, and then the nut is moved towards the ball deflect unit until the latter is perfectly settled in position in corresponding axial cavity of the nut.

3. The ball screw unit of claim 1, wherein the circulation balls are fed into the nut from the radial cavity.
